(19) United States
(12) Patent Application Publication
(10) Pub. No.: US 2026/0206804 A1
(43) Pub. Date: Jul. 23, 2026

(54) PROCESS FOR MAKING A MEAT PRODUCT

(71) Applicant: GENERAL MILLS, INC., Minneapolis, MN (US)

(72) Inventors: Eric R. ENGESSER, Minnetrista, MN (US); Mario Sergio GUADALUPE DAQUI, Maple Grove, MN (US); James D. NELSON, Bloomington, MN (US); Omar ZAYAS SANTIAGO, Minneapolis, MN (US); Andriana V. SCHIRACK, Plymouth, MN (US); Jennifer SWANSON, Brooklyn Park, MN (US)

(73) Assignee: GENERAL MILLS, INC., Minneapolis, MN (US)

(21) Appl. No.: 19/137,723

(22) PCT Filed: Dec. 21, 2023
(86) PCT No.: PCT/US2023/085362

§ 371 Date: Jun. 11, 2025

Related U.S. Application Data
(60) Provisional application No. 63/434,560, filed on Dec. 22, 2022.

(51) Int. Cl. A23L 13/60; A23L 13/00; A23L 13/40; A23L 29/219

(52) U.S. Cl. CPC A23L 13/67; A23L 13/03; A23L 13/426; A23L 13/428; A23L 29/219

(57) ABSTRACT

A method of making an meat product includes providing a meat batter that contains a modified starch in an amount of about 1% to about 15% by weight, forming the meat batter into a shaped composition, and cooking the shaped composition to form the meat product. The method facilitates production of a meat product that retains at least 65% of the fat content of a meat batter. In some embodiments, a meat product made according to a method provided herein substantially retains the shape of the shaped composition.

### TECHNICAL FIELD

This disclosure relates to meat products and methods of making meat products from a meat batter.

### BACKGROUND

Meat products are widely used in frozen foods and readymade conventional meals. For example, meat is a common component in frozen pizzas and other hot snacks. The time and costs associated with production requirements for traditionally produced meat products, such as pepperoni, which include stuffing into a casing and often include fermentation and/or curing steps, have prompted the food industry to search for alternatives to processes of making such meat products.

### SUMMARY

In general, this disclosure is directed to methods of making meat products from a meat batter that substantially retain mass and a formed shape during a cooking step. The meat product includes modified (e.g., crosslinked, hydroxypropylated, and/or acetylated) starch.

A process of making a meat product is provided herein. The process includes combining ingredients to form a meat batter, forming the meat batter into a shaped composition, the shaped composition having a fat content of about 20% to about 40% by weight of the shaped composition and a moisture content of about 45% to about 65% by weight of the shaped composition; and cooking the shaped composition at a temperature of from about 130° F. to about 250° F. to produce the meat product, wherein the meat product retains at least 65% of the fat content of the shaped composition and retains at least 45% of the moisture content of the shaped composition. The ingredients in the meat batter include a meat and fat component included in an amount of about 60% to about 85% by weight of the meat batter, the meat and fat component including lean meat in an amount of about 35% to about 60% by weight of the meat batter and fat in an amount of about 20% to about 40% by weight of the meat batter; modified starch in an amount of about 1% to about 15% or about 1% to about 6% by weight of the meat batter; and a moisture content of about 45% to about 65% by weight of the meat batter.

In some embodiments, the lean meat can include chicken and/or pork. In some embodiments, the fat can include an animal fat and/or a vegetable fat. In some embodiments, the meat batter can include a vegetable protein, such as a soy protein.

In some embodiments, the modified starch can be crosslinked, hydroxypropylated and/or acetylated. In some embodiments, the modified starch can have a peak viscosity of from about 6,000 cPs to about 10,000 cPs as measured by rapid viscosity analysis (RVA). In some embodiments, the modified starch can have a final viscosity of from about 4,000 cPs to about 10,000 cPs as measured by rapid viscosity analysis (RVA).

In some embodiments, the meat product can include a hydrophilic colorant and/or a hydrophobic colorant. In some embodiments, the meat batter can include an acidulant, such as an organic acid. In some embodiments, an acidulant can be an encapsulated acidulant.

In some embodiments, the shaped composition can have a regular shape and the meat product substantially retains the regular shape of the shaped composition. In some embodiments, a regular shape can be a cuboidal shape.

In some embodiments, the cooking can be performed in a continuous oil cooker or a continuous water cooker.

In some embodiments, the modified starch can be at least partially hydrated before or during the combining step.

In some embodiments, the forming step can include heating at least a portion of a surface of the shaped composition.

In some embodiments, the shaped composition can be cooked at a temperature of about 145° F. to about 200° F.

In some embodiments, a process of making a meat product can include a step of freezing the meat product.

A meat product made by a process described herein is also provided. A frozen food product including such a meat product is provided. In some embodiments, the frozen food product can be a frozen pizza or a frozen snack.

The details of one or more examples are set forth in the accompanying drawings and the description below. Other features, objects, and advantages will be apparent from the description and drawings, and from the claims.

### DETAILED DESCRIPTION

This disclosure generally relates to meat products made from a meat batter, such as meat products suitable for toppings on refrigerated or frozen foods, such as pizza, snack rolls, and the like.

Many meat products are made from a meat batter, also termed meat emulsion, which is then further processed (e.g., formed, smoked, cooked, fermented, cured, and the like) to produce a meat product suitable for consumption. Generally, for meat products included in refrigerated or frozen foods, a meat batter is processed and then cooked to kill microorganisms in the meat product to ensure food safety and quality over a refrigerated or frozen shelf life. For some meat products, especially those made from meat batters with fat content less than 18% by weight, a meat batter can be formed into pieces and then directly cooked without losing significant fat and/or water content possibly because the meat proteins act to bind the water and fat during the cooking process. However, for meat products made from meat batters containing about 20% by weight fat or more, the meat batter is typically put inside a casing, and often fermented and/or cured to develop flavor and target pH level, before cooking. Water and fat are at least partially retained inside the casing during cooking, especially with synthetic casings. The meat product can then be further processed, such as by cutting into pieces, such as slices or cubes, without losing significant fat and water. However, the steps of filling a casing, followed by cooking and cutting, are time and resource intensive.

The inventors of the presently described invention were tasked with developing new formulations and methods of producing meat products with relatively high fat content that have acceptable yields without requiring cooking in a casing. On the other hand, such meat products also needed to provide a cooking and eating experience that consumers have come to expect from meat products that are typically cooked in casings. For example, consumers expect that a pizza topping should express melted fat onto the surface of a pizza when the pizza is baked. In addition, a meat product still needed to have a texture and flavor that consumers enjoy.

After testing several approaches that were expected to improve yield, such as soy protein and fiber, and achieving nominal or no improvement in yield or creating a poor eating experience, it was discovered that a new formulation for a meat batter including modified (e.g., crosslinked, hydroxypropylated, and/or acetylated) starch in an amount of about 1% to about 15% by weight of the meat batter improves retention of fat and water during a cooking step at about 130° F. to about 250° F. (e.g., about 145° F. to about 200° F.) without requiring a casing to produce a meat product. In general, a meat batter that includes a fat content of about 20% to about 40% (e.g., about 22% to about 35%) by weight, modified starch in an amount of about 1% to about 15% (e.g., about 1% to about 10%, or about 1% to about 6%) by weight, and a moisture content of about 45% to about 65% by weight can be formed and cooked without a casing at a temperature of about 130° F. to about 250° F. (e.g., about 145° F. to about 200° F.) to result in a meat product that retains at least 65% of the fat content of the meat batter and at least 45% of the moisture content of the meat batter. Beneficially, although fat is retained during a production cooking step at 130° F. to 250° F., a meat product described herein still provides the expected “oil out” during consumer cooking at temperatures exceeding 350° F. (e.g., at least 375° F., or at least 400° F.), such as during baking of a frozen pizza.

In some embodiments, such a meat batter can also be formed into a regular shape, such as a cuboidal or cylindrical shape, and substantially retain the shape during cooking rather than becoming irregular or random, or significantly distorting during cooking. Thus, in some embodiments, a meat product can be made without requiring cooking in a casing, yet be formed to mimic the shape of pieces cut from a meat product in a casing.

In addition, since the presently described formulations and methods render a casing no longer required to achieve an acceptable yield for higher fat meat products, flavorants and/or acidulants can be used to mimic the flavor of a meat product that has been fermented and/or cured in a casing.

Generally, a process of making a meat product provided herein includes at least the following steps: forming a meat batter, forming the meat batter into a shaped composition, and cooking the shaped composition to make the meat product.

A meat batter suitable for use in a process provided herein includes a meat and fat component in an amount of about 60% to about 85% (e.g., about 65% to about 80%, or about 70% to about 80%) by weight of the meat batter. A meat and fat component includes lean meat in an amount of about 35% to about 60% (e.g., about 40% to about 55%) by weight of the meat batter. As used herein, the term “lean meat” refers to the portion of a meat ingredient (e.g., chicken, pork, beef, and the like, or any combination thereof) minus any fat also included in the meat ingredient. That is, a meat ingredient that includes 40% fat by weight also contains 60% lean meat by weight, including any muscle, water, minerals, and the like.

A meat and fat component in a meat batter also includes fat in an amount of about 20% to about 40% (e.g., about 22% to about 35%) by weight of the meat batter. It is to be understood that fat in a meat and fat component can be from any source. For example, fat in a meat and fat component can be provided by a meat ingredient included in a meat batter, fat trimmings from processing of a meat ingredient not included in the meat batter, and/or from non-meat sources, such as oils or fats from dairy, plants, microbes, and the like. In some embodiments, if a fat from a non-meat source is used, it can be selected as having a melting point similar to meat-based fats.

A meat batter includes modified starch in an amount of about 1% to about 15% (e.g., about 1% to about 10%, about 1% to about 8%, or about 1% to about 6%) by weight of the meat batter. Any starch source suitable for use in a food, such as corn starch, tapioca starch, potato starch, and the like, or any combination thereof, can be used in a meat batter. As used herein, the term “modified” used to describe a starch does not include native or pregelatinized starch. Native or pregelatinized starches can be included but provide little if any benefit.

In some embodiments, a modified starch in a meat batter can have a peak viscosity of from about 6,000 cPs to about 10,000 cPs (e.g., about 6,000 cPs to about 8,500 cPs) as measured by rapid viscosity analysis (RVA). In some embodiments, a modified starch in a meat batter can have a final viscosity of from about 4,000 cPs to about 10,000 cPs (e.g., about 5,500 cPs to about 9,500 cPs) as measured by RVA. As used herein, RVA analysis of starch viscosity is measured using Perten Instruments RVA model 4500 (PerkinElmer, Inc., Waltham, MA, USA) according to AACC method 76-21.02, applying the STD1 profile from Table I and the starch moisture correction from Table III (AACC Approved Methods of Analysis, 11th Ed. Method 76-21.02, General Pasting Method for Wheat or Rye Flour or Starch Using the Rapid Visco Analyser. First approved Oct. 15, 1997; revised November 2017. Cereals & Grains Association, St. Paul, MN, U.S.A. http://dx.doi.org/10.1094/AACCIntMethod-76-21.02).

A meat batter can include other ingredients, such as plant protein (e.g., soy protein, wheat protein, and the like), flavorants (e.g., seasonings), colorants (e.g., hydrophilic and/or hydrophobic colorants), acidulants (e.g., organic acids and/or acid salts, encapsulated acidulant), curing salts, preservatives, and the like, or any combination thereof. Such ingredients are typically included in minor amounts in a meat batter (e.g., less than 10% by weight each, or less than 15% by weight total). For example, a vegetable protein (e.g., soy protein) can be included in an amount of up 10% (e.g., up to about 6%, or about 1% to about 4%) by weight of a meat batter.

In some embodiments, a meat batter can include a colorant that is hydrophilic. Such a colorant can resist leaching from a meat product as the meat product oils out during consumer cooking. In some embodiments, a meat batter can include both a colorant that is hydrophilic and a colorant that is hydrophobic. Such a combination of colorants can result in meat product that retains color, yet also leaches some color during oil out when a consumer cooks it, providing a visual indication of oil out while also preventing pieces of the meat product becoming pale.

Moisture content of a meat batter is typically from about 45% to about 65% by weight. It is to be understood that the moisture content of a meat batter includes water from any ingredients, as well as added water.

A meat batter can be made by combining ingredients to achieve the above-described composition using any appropriate method, and may include optional steps, such as size reduction of meat ingredients. A suitable meat batter is typically a homogenous mixture with meat and fat particles that are visually indistinguishable.

In some embodiments, modified starch can be at least partially hydrated before or during combining ingredients to make a meat batter.

A meat batter can be formed into a shaped composition using any appropriate method, such as extrusion through a die, followed by cutting, using a water wheel, or molding in a form. A shaped composition typically contains about the same moisture content and fat content as a meat batter used to make it.

A shaped composition can be in any shape. Especially preferred is a regular shape, such as a cuboidal shape or a cylindrical shape. However, it is to be understood that a regular shape may be designed to appear random and/or irregular. However, observation of multiple pieces will generally reveal that many of the pieces exhibit the same shape. In some embodiments, heat can be applied to at least a portion of a surface of a shaped composition as it is being formed. Such heating can improve retention of the shape of a shaped composition and/or prevent agglomeration of pieces of shaped composition during cooking.

A shaped composition is cooked at a temperature of from about 130° F. to about 250° F. (e.g., about 145° F. to about 200° F.) to produce a meat product. The shaped composition is typically cooked for a time and temperature consistent with United States Department of Agriculture (USDA) Food Safety and Inspection Service (FSIS) safe harbor cooking conditions for cooked meat and poultry products. See, FSIS: Salmonella Compliance Guidelines for Small and Very Small Meat and Poultry Establishments that Produce Ready-to-Eat (RTE) Products and Revised Appendix A, December 2021. It is to be understood that a shaped composition may not be considered ready-to-eat even if it has been cooked in compliance with safe harbor cooking conditions, especially if it is further processed and/or comes into contact with other food ingredients that are not ready-to-eat.

Cooking of a shaped composition can be done using any suitable process and/or equipment to form a meat product. For example, a shaped composition can be cooked using a continuous cooker (e.g., a continuous oil cooker or a continuous water cooker). A meat product retains at least 65% (e.g., at least 70%) of the fat content of a shaped product. A meat product made using a meat batter and method provided herein typically contains at least 13% by weight fat (e.g., at least 20%, or about 20% to about 30%).

In some embodiments, a meat product can be refrigerated and/or frozen. A meat product can be refrigerated and/or frozen and packaged for sale as is, or can be applied to or incorporated into a food, such as a pizza or a snack roll.

Any product containing a meat product according to the disclosure may be prepared, packaged, refrigerated or frozen, stored, and optionally shipped in a refrigerated or frozen state for commercial distribution and sale. A frozen food can be stored frozen for an extended period and eventually used by a private consumer or commercial user by heating the frozen food product (with optional thawing) in a conventional, convection, or microwave oven. A refrigerated food can typically be stored refrigerated for a shorter period of time, but can be similarly used by a private consumer or commercial user by heating prior to consumption.

### Example 1

A base meat emulsion formulation was assessed for water and fat retention during cooking. The base meat emulsion included a meat and fat component that was a chicken and pork blend contributing about 70% to about 75% by weight of the emulsion. The emulsion had a fat content of about 25% to about 30% by weight and a moisture content of about 50% to about 60% of the emulsion. To increase water and fat retention in the meat emulsion system, different ingredients were used individually and in combination during the mixing process. These ingredients included protein (soy protein isolate (SPI), soy protein concentrate (SPC), and gluten), citrus fiber, wheat flour and starch (native and modified) added up to 5.5% by weight of the emulsion formulation. Table 1 shows the results.

TABLE 1

| Ingredient 1 | Ingredient 2 | Ingredient 3 | Result |
|---|---|---|---|
| SPI (5.5%) | None | None | Low yield - control |
| Citrus fiber (3%) | SPI (2.5%) | None | Improved yield, |
| | | | poor texture |
| Citrus fiber (2%) | Modified | SPI (1.5%) | Improved yield, |
| | starch (2%) | | poor texture |
| SPC (5.5%) | None | None | No significant |
| | | | improvement over |
| | | | control |
| Wheat flour | None | None | No significant |
| (5.5%) | | | improvement over |
| | | | control |
| Gluten (5.5%) | None | None | Lower yield than |
| | | | control |
| Modified starch | None | None | Improved yield, |
| (5.5%) | | | good texture |
| Modified | SPI (3.5%) | None | Improved yield, |
| starch (2%) | | | good texture |

It was initially believed that the selected proteins would improve water and fat retention because the selected proteins are known to have emulsifying properties, which was hypothesized to help stabilize the emulsion and gel network. However, the selected proteins failed to significantly increase yield. Although citrus fiber was shown to have water and fat retention properties in meat products in published studies, it resulted in improved yield but had a significant negative impact on texture and flavor, even at low levels. Native starch, including pregelatinized starch failed to significantly increase yield. Wheat flour, which contains both gluten and starch, also did not improve yield. Only modified starch achieved both a significant yield increase and good eating qualities.

1. A process of making a meat product, comprising:
a. combining ingredients to form a meat batter, the ingredients comprising:
1) a meat and fat component included in an amount of about 60% to about 85% by weight of the meat batter, the meat and fat component including lean meat in an amount of about 35% to about 60% by weight of the meat batter and fat in an amount of about 20% to about 40% by weight of the meat batter;
2) modified starch in an amount of about 1% to about 15% by weight of the meat batter; and
3) a moisture content of about 45% to about 65% by weight of the meat batter;
b. forming the meat batter into a shaped composition, the shaped composition having a fat content of about 20% to about 40% by weight of the shaped composition and a moisture content of about 45% to about 65% by weight of the shaped composition; and
c. cooking the shaped composition at a temperature of from about 130° F. to about 250° F. to produce the meat product, wherein the meat product retains at least 65% of the fat content of the shaped composition and retains at least 45% of the moisture content of the shaped composition.

2. The process of claim 1, wherein the shaped composition has a regular shape and the meat product substantially retains the regular shape of the shaped composition.

3. (canceled)

4. The process of claim 1, wherein the cooking is performed in a continuous oil cooker or a continuous water cooker.

5. The process of claim 1, wherein the meat product comprises a hydrophilic colorant or a hydrophobic colorant.

6. (canceled)

7. The process of claim 1, wherein the modified starch is at least partially hydrated before or during the combining step.

8. The process of claim 1, wherein the lean meat comprises chicken or pork.

9. The process of claim 1, wherein the fat comprises an animal fat or a vegetable fat.

10. (canceled)

11. The process of claim 1, wherein the meat batter comprises a vegetable protein.

12. The process of claim 11, wherein the vegetable protein comprises soy protein.

13. The process of claim 1, wherein the forming step comprises heating at least a portion of a surface of the shaped composition.

14. The process of claim 1, wherein the modified starch is included in an amount of about 1% to about 6% by weight of the meat batter.

15. The process of claim 1, wherein the modified starch is crosslinked.

16. The process of claim 1, wherein the modified starch is hydroxypropylated or acetylated.

17. The process of claim 1, wherein the modified starch has:
a. a peak viscosity of from about 6,000 cPs to about 10,000 cPs as measured by rapid viscosity analysis (RVA); or
b. a final viscosity of from about 4,000 cPs to about 10,000 cPs as measured by rapid viscosity analysis (RVA).

18. (canceled)

19. The process of claim 1, wherein the meat batter comprises an acidulant.

20. The process of claim 19, wherein the acidulant comprises an organic acid.

21. The process of claim 1, wherein the shaped composition is cooked at a temperature of about 145° F. to about 200° F.

22. The process of claim 1, comprising a step of freezing the meat product.

23. A meat product made by a process according to claim 1.

24. A frozen food product including a meat product made by a process according to claim 1.

25. (canceled)
